(19) United States
(12) Patent Application Publication
(10) Pub. No.: US 2012/0254479 A1
(43) Pub. Date: Oct. 4, 2012

(54) System and Method for Supplementing and/or Modifying Operations of a Mobile Computing Device Using a Cover

(76) Inventor: Yoshimichi Matsuoka, Cupertino, CA (US)

(21) Appl. No.: 13/077,906

(22) Filed: Mar. 31, 2011

(51) Int. Cl. G06F 3/00

(52) U.S. Cl. 710/16

(57) ABSTRACT

A mobile computing device is disclosed. The mobile computing device comprises a housing, an internal communication port and one or more processors. A user may attach various covers to the housing of the mobile computing device interchangeably. The one or more processors are configured to detect whether the attached cover is a power accessory and/or a data accessory via the internal communication port. The attached cover includes a communication port that mates with the internal communication port of the mobile computing device when properly engaged with the housing. Based on the detection, if the cover is a power accessory, the one or more processors are configured to modify power operations of the mobile computing device, and if the cover is a data accessory, the one or more processors are configured to modify a functionality of the mobile computing device.

### RELATED APPLICATIONS

This application incorporates by reference U.S. patent application Ser. No. 12/652,014 filed on Jan. 4, 2010, entitled INTERIOR CONNECTOR SCHEME FOR ACCESSORIZING A MOBILE COMPUTING DEVICE WITH A REMOVEABLE HOUSING SEGMENT, and U.S. patent application Ser. No. 12/651,087 filed on Nov. 18, 2009, entitled PORTABLE POWER SUPPLY DEVICE FOR MOBILE COMPUTING DEVICES; the aforementioned applications are hereby incorporated by reference in its entirety.

### TECHNICAL FIELD

The disclosed embodiments relate generally to the field of operating mobile computing devices. In particular, embodiments described herein pertain to a system and method for supplementing and/or modifying operations of a mobile computing device using a cover.

### BACKGROUND OF THE INVENTION

Portable electronic devices, such as cellular phones and personal digital assistants (PDAs), have become so integrated into society that they are heavily relied on by users for performing a variety of different tasks. Users can use these devices for a variety of different purposes. For example, cellular phones may not only be used for making phone calls, but may also be used to read electronic books and newspapers, watch videos and television shows, browse the Internet, take photographs, play games, send and receive emails, and perform other tasks.

In designing different types of cellular phones, manufacturers make a variety of different cellular phones that include different features. For example, a manufacturer may design a cellular phone that is aimed more for children or younger adults that may not have the same features (e.g., less features) as a cellular phone more suited for a working adult.

With the complexity of mobile devices, it is beneficial to enable a user to after various functionalities and/or operations of his or her computing device by easily adding or removing certain features to and from the device.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 is a general overview of a mobile computing device that is configured to mate with interchangeable covers, according to embodiments;

FIG. 2A is a flow chart illustrating a method for operating a mobile computing device under an embodiment;

FIG. 2B is a flow chart illustrating a method for detecting a cover according to an embodiment;

FIG. 2C illustrates a system for detecting a cover and for operating a mobile computing device under an embodiment;

FIG. 3A illustrates a simplified block diagram of a cover for a mobile computing device under an embodiment;

FIG. 3B illustrates a front view of a cover for a mobile computing device, according to an embodiment;

FIG. 3C illustrates a back view of the cover illustrated in FIG. 3B under an embodiment;

FIG. 4A illustrates a simplified block diagram of a cover for a mobile computing device under another embodiment;

FIG. 4B illustrates a front view of a cover for a mobile computing device under an embodiment;

FIG. 4C illustrates a back view of the cover illustrated in FIG. 4B, under an embodiment;

FIGS. 5A and 5B illustrate a cover being engaged with a mobile computing device according to an embodiment; and

FIG. 6 is a simplified block diagram of a mobile device that is coupled with a cover under an embodiment.

### DETAILED DESCRIPTION

Embodiments described herein include a cover for a mobile computing device which enhances or augments the functionality of the mobile computing device. Still further, some embodiments include a platform of covers that are interchangeable on devices in order to provide various functionality and resources for a mobile computing device. Among other uses, the covers may accessorize a device to provide power, provide data and programming resources, enable profile or mode operation, and/or restrict use of the device.

In an embodiment, a mobile computing device that is configured to detect a cover when it is attached to the housing of the mobile computing device. Upon detecting the cover, the mobile computing device automatically modifies or alters its various operations and/or functionalities. In some embodiments, the operations and/or functionalities that are modified or altered correspond to the physical attributes or components of the cover that is attached to the mobile computing device.

According to one or more embodiments, the mobile computing device includes an internal communication port that is configured to mate with a communication port of a cover. When the cover for the mobile computing device is properly engaged with the housing of the mobile computing device, the internal communication port mates with the communication port of the cover. The mobile computing device detects whether the cover is a power accessory, a data accessory, or both via the mated communication ports.

In some embodiments, based on the detection, if the cover is determined to be a power accessory, the one or more processors of the mobile computing device are configured to modify various power operations of the mobile computing device. If the cover is determined to be a data accessory, the one or more processors are configured to modify an operation and/or a functionality of the mobile computing device.

In one embodiment, the cover includes a memory resource that is coupled to the communication port of the cover. The memory resource stores data that identifies whether the cover is a power accessory and/or a data accessory. In another embodiment, because the memory resource is coupled to the communication port of the cover, when the cover is properly engaged with the housing of the mobile computing device, the one or more processors of the mobile computing device can read the data stored in the memory resource via the internal communication port and the communication port of the cover.

In some embodiments, the memory resource of the cover also includes data corresponding to instructions for modifying power operations and/or modifying the functionality of the mobile computing device. The mobile computing device can read this data in order to modify power operations of the mobile computing device and/or the functionality of the mobile computing device. In other embodiments, data corresponding to instructions for modifying power operations and/or modifying the functionality of the mobile computing device can be stored in a memory resource of the mobile computing device.

Embodiments described herein also provide a cover that includes a solar panel interface. In other embodiments, the cover includes a battery that is coupled to the communication port of the cover. The cover may be a power accessory that enables the mobile computing device to receive power from components in the cover. In some embodiments, the cover includes both the solar panel interface as well as a battery, and also includes other electrical components.

In alternative embodiments, the cover can be a data accessory so that when the cover is engaged with the housing of the mobile computing device, the mobile computing device automatically modifies a functionality. The cover may have certain physical attributes that relate to the different modifications of the functionality of the mobile computing device. The cover may have a graphic image or design, various shapes, colors, or textures. In some embodiments, modifying the functionality of the mobile computing device includes changing an operation mode of the mobile computing device or changing one or more settings of the mobile computing device.

Some embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component, can exist on a hardware component independently of other modules/components or a module/component can be a shared element or process of other modules/components, programs or machines. A module or component may reside on one machine, such as on a client or on a server, or a module/component may be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources, including data ports, and signal lines (optical, electrical etc.), unless stated otherwise.

Some embodiments described herein may generally require the use of computers, including processing and memory resources. For example, systems described herein may be implemented on a server or network service. Such servers may connect and be used by users over networks such as the Internet, or by a combination of networks, such as cellular networks and the Internet. Alternatively, one or more embodiments described herein may be implemented locally, in whole or in part, on computing machines such as desktops, cellular phones, personal digital assistances, laptop computers, tablet devices, or other computing devices. Thus, memory, processing and network resources may all be used in connection with the establishment, use or performance of any embodiment described herein (including with the performance of any method or with the implementation of any system).

Furthermore, some embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

Overview

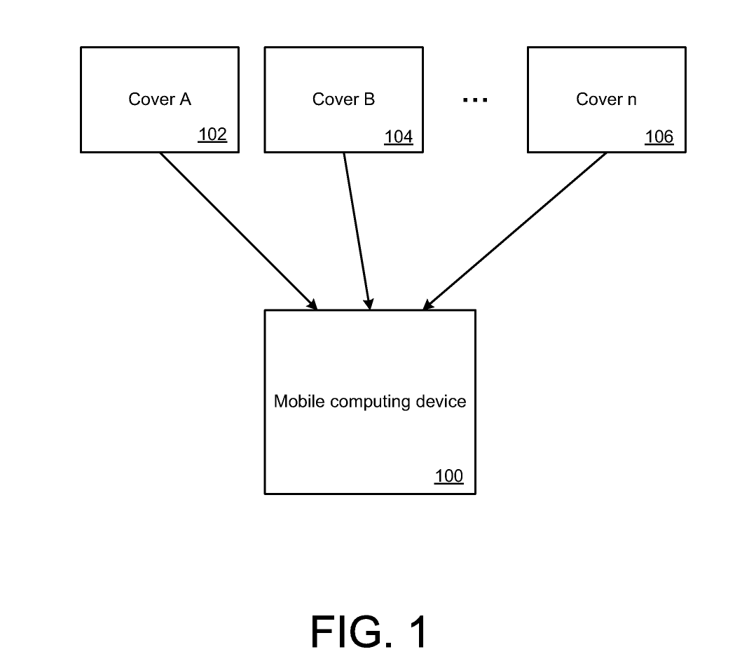

FIG. 1 is a general overview of a mobile computing device that is configured to mate with interchangeable covers, according to embodiments. In some embodiments, an accessorial platform is devised to provide covers with varying functionality for use with a mobile computing device. Individual covers can be interchangeable to enable a user to pick and choose what cover to attach to his or her mobile computing device. In an embodiment, a mobile computing device 100 is further configured to detect a cover that is attached. Based on signals received (e.g. logic, power, data), the mobile computing device is configured to automatically perform, alter, or modify its operations and/or functionalities.

As examples, the mobile computing device can correspond to any device that includes roaming wireless network and/or telephony capabilities, including cellular telephony devices and/or mobile messengers. In particular, embodiments described herein may apply to numerous kinds of mobile or small form-factor computing devices. One type of mobile computing device that may be configured to include embodiments described herein includes a computer telephony device, such as a cellular phone or mobile device with voice-telephony applications (sometimes called “smart phone”). A computing device such as described may be small enough to fit in one hand, while providing cellular telephony features in combination with other applications, such as messaging, web browsing, media playback, personal information management (e.g., such as contact records management, calendar applications, tasks lists), image or video/media capture and other functionality. Mobile computing devices in particular may have numerous types of input mechanisms and user-interface features, such as keyboards or keypads, mufti-directional or navigation buttons, application or action buttons, and contact or touch-sensitive display screens. Some devices may include combinations of keyboard, button panel area, and display screen on one façade. The button panel region may occupy a band between the keypad and the display area, and include a navigation button and multiple application buttons or action buttons.

Specific types of messaging that may be performed include messaging for email applications, Short Message Service (SMS) messages, Multimedia Message Service (MMS) messages, and proprietary voice exchange applications (such as SKYPE). Still further, other types of computing devices contemplated with embodiments described herein include laptop or notebook computers, ultra-mobile computers, personal digital assistants, and other mufti-functional computing devices or mobile/portable devices.

Still further, one or more embodiments may be implemented through any type of computing device such as a desktop computer that is configured to include real-time voice data exchange (e.g. through use of Internet Protocol telephony). Still further, other types of computer telephony devices exist, including standalone devices that connect directly to a telephone network (whether Internet Protocol or Public Switch Telephony System (PSTN)) and provide software interfaces and applications.

As used herein, the term “cover” is a structure that can be mated to a mobile computing device in order to provide at least a portion of a façade or exterior section of a housing of a mobile computing device. In particular, a mobile computing device may include a housing that has a portion or a façade that is removable or detachable from the rest of the housing. The cover may engage with the remainder of the housing to fully or substantially complete the entirety of the housing of the mobile computing device. In one embodiment, the cover engages with the housing of the mobile computing device so that the cover and housing are flush about each other.

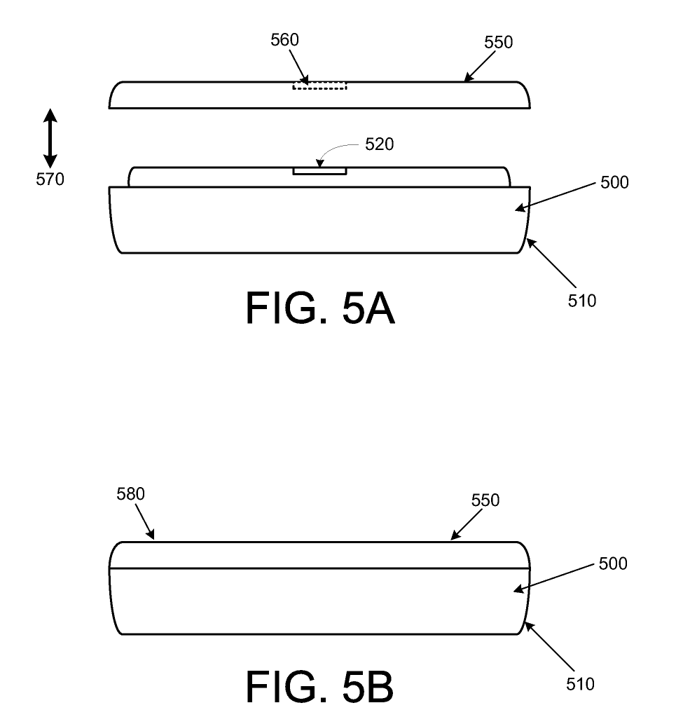

Each of a variety of different covers may be configured or designed to engage with the housing of the mobile computing device. In some embodiments, the mobile computing device may include a default cover that may be removed by a user and be replaced with a different cover in its place. Depending on the design of the mobile computing device, the cover may fit on various positions of the mobile computing device (e.g., the cover may cover a portion or more of the front face of the mobile computing device, or the side or rear face). A side view of a cover being engaged with the housing of the mobile computing device can be seen in FIGS. 5A and 5B.

A plurality of covers 102, 104, 106 may each be configured to attach to the mobile computing device 100. Each of the covers may include at least a memory resource coupled to a communication port. When a cover is properly engaged with the housing of the mobile computing device 100, the communication port of the attached cover will align with an internal communication port of the mobile computing device 100. The communication port is configured to mate with the internal communication port of the mobile computing device 100 to enable an exchange of both power and/or data between the attached cover and the mobile computing device 100.

In some embodiments, memory resource of a cover are coupled to the communication port so that when the communication port is mated with the internal communication port of the mobile computing device 100, data can be transferred from the memory resource to the processor of the mobile computing device 100 (or data may be read by the processor of the mobile computing device 100). For each cover 102, 104, 106, the memory resource may store data corresponding to each of the covers (including data identifying whether the cover is a power accessory and/or a data accessory). Still further, the memory resource can include instructions for performing or modifying operations and/or functionalities of the mobile computing device 100.

The various individual covers 102, 104, 106 may be of kind or type that is dictated by functionality provided, form factor (e.g. thickness), design and purpose. Accordingly, the individual covers 102, 104, 106 may represent a type or kind of cover, with corresponding characteristics and resources. The different kinds of covers 102, 104, 106 have different characteristics and components in order to enhance the functionality of the mobile computing device 100 when a particular cover is attached to the mobile computing device 100. In some embodiments, one or more of the covers 102, 104, 106 may be a power accessory so that power can be provided to the mobile computing device 100. For example, Cover A 102 can include a solar power interface that is configured to receive light energy and convert the energy into electrical power. The solar power interface may be coupled to the communication port of the cover 102 in order to provide power to the mobile computing device 100 via the mated communication ports.

In another example, Cover B 104 may include a secondary battery (so that when the cover 104 is attached, the mobile computing device 100 may have two battery sources, i.e., the internal battery of the mobile computing device 100 and the battery of the cover 104). The secondary battery may provide power to the mobile computing device 100. Other embodiments include a cover with an inductive signal interface so that the cover may receive power inductively from another source and transfer the power to the mobile computing device 100.

Depending on the type of cover that is attached to the mobile computing device 100, the mobile computing device 100 may modify or perform various operations and/or functionalities. For example, if a power accessory cover is attached to the mobile computing device 100, the mobile computing device 100 may modify the power operations or scheme in order to change the order or sequence in which the mobile computing device 100 receives its power (e.g., from the internal battery first or from the secondary battery on the cover first, or from a solar power interface).

In other embodiments, one or more of the covers 102, 104, 106 may be a data accessory that modifies operations and/or functionalities of the mobile computing device 100. If an attached cover is a data accessory, the mobile computing device 100 may process data in order to effect a change in its operations and/or functionalities. According to an embodiment, data corresponding to instructions for altering the operations and/or functionalities of the mobile computing device 100 may be stored in a memory resource of the cover. In other embodiments, the instructions for modifying operations and/or functionalities may be stored in a memory resource of the mobile computing device 100. The mobile computing device 100 may determine what data accessory cover is attached to it and access its own memory resource to determine how to modify its operations and/or functionalities. Other embodiments include the instructions being stored in a network server so that the mobile computing device may receive instructions for modifying its operations and/or functionalities from an external server (e.g., through use of a network or cellular network).

A data accessory cover may be used to modify various mobile computing device operations and/or functionalities, such as changing an operation mode of the mobile computing device or modifying device settings. For example, Cover 106 may be a data accessory that may enable or disable certain profiles or applications from being accessed. Depending on the data accessory cover that is attached to the mobile computing device 100, data may be processed in order to modify or after the operations and/or functionalities of the mobile computing device. Because a data accessory cover does not include any power components (unless the cover is both a power accessory and a data accessory), the data accessory cover includes physical attributes or characteristics to distinguish itself from other covers.

Physical attributes may include different sizes, shapes, textures, colors, graphic designs, materials, etc. that enables a user to distinguish one cover from another. Depending on the data stored in the memory resource of the cover, the data may correspond to one or more physical attributes of the cover in order to effect a change in operation and/or functionality of the device. For example, a cover that has a bumpy texture may include data instructing the mobile computing device to change the design settings so that the mobile computing device vibrates when various operations are performed on the mobile computing device.

### Flow Charts

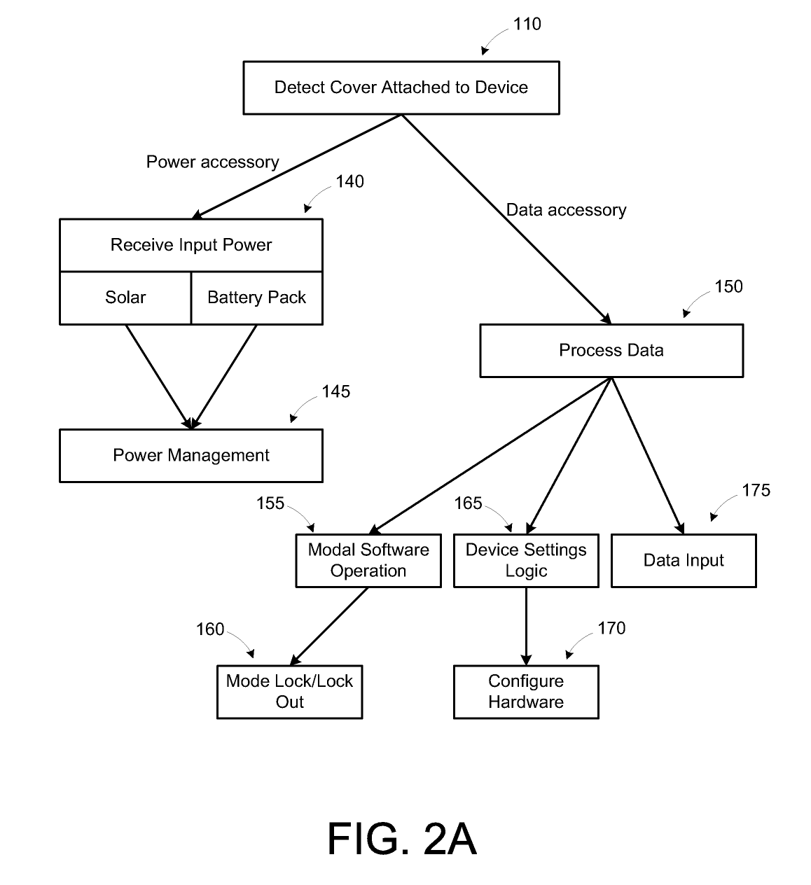

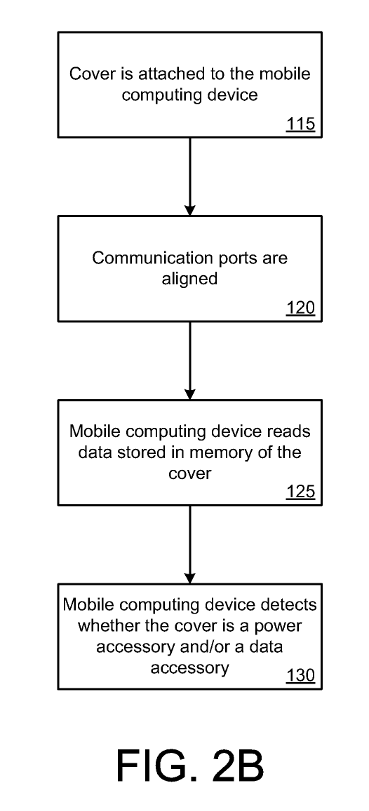

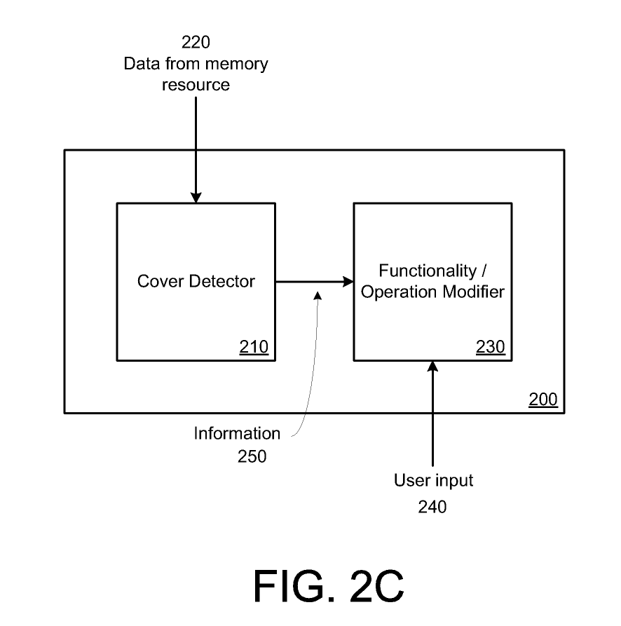

FIG. 2A is a flow chart illustrating a method for operating a mobile computing device that is mated to an enhanced cover, according to one or more embodiments. A method such as described with FIG. 2A may be implemented using, for examples, elements shown and described with FIG. 1. As such, references to elements of FIG. 1 are intended to illustrate only suitable elements for performing a step or sub-step being described. Steps or sub-steps described may be performed by one or more processors of the mobile computing device using various programmatic elements.

In one embodiment, FIG. 2A is illustrative of a mobile computing device that can perform, after or modify various operations and/or functionalities depending on the type of cover that is attached to or engaged with the mobile computing device. In step 110, the mobile computing device detects a cover that is attached to the mobile computing device. Once the cover is engaged with the housing of the mobile computing device, the mobile computing device may detect what cover or type of cover is attached to it. As discussed, each cover has a memory resource that is coupled to a communication port. When a cover is properly attached to the mobile computing device, the communication port of the cover mates with an internal communication port of the mobile computing device. Through use of the mated communication ports, the mobile computing device may detect what type of cover is attached to it. The detection of the cover (step 110) may further be explained with reference to FIG. 2B.

If the cover is a power accessory, the mobile computing device may receive power from the cover (step 140). On the other hand, if the cover is a data accessory, the mobile computing device may process data in order to effect a change in operations and/or functionalities (step 150). In other embodiments, the cover may be both a data accessory and a power accessory so that the mobile computing device performs both sets of steps stemming from steps 140 and 150.

In step 140, the mobile computing device may receive power from the cover. In some embodiments, the attached cover may include a solar power interface that is configured to receive light energy and convert the energy into electrical power. The solar power interface may be coupled to the communication port of the cover in order to provide power to the mobile computing device via the mated communication ports. In other embodiments, the cover may include a secondary battery (so that when the cover is attached, the mobile computing device may have two battery sources, i.e., the internal battery of the mobile computing device and the battery of the cover) so that the secondary battery may provide power to the mobile computing device. Other embodiments include a cover with an inductive signal interface so that the cover may receive power inductively from another source and transfer the power to the mobile computing device. Depending on the data stored in the memory resource of the cover, the mobile computing device may determine what electrical components and/or power components are included with the attached cover. In other embodiments, the cover may include multiple power components (e.g., a solar power interface and/or extra battery and/or inductive signal interface).

Depending on the different components that are included with the various covers, in step 145, the mobile computing device may modify or after power operations of the mobile computing device. For example, when a cover with a secondary battery is attached to the mobile computing device, the mobile computing device may receive power from the cover via the mated communication ports. The mobile computing device may modify the power operations or scheme in order to change the order or sequence in which the mobile computing device receives its power (e.g., from the internal battery first or from the secondary battery on the cover first). The mobile computing device may also programmatically determine what operations (making a phone call, text messaging, writing emails, etc.) or applications (calendar application, social network application, game, etc.) use which battery source (or which battery is used first for various operations). Similarly, in another example, when the cover with a battery is attached to the mobile computing device, the mobile computing device may modify power operations by changing the order in which the mobile computing device recharges the batteries.

In some embodiments, power operations may be modified to control the order or sequence of both power consumption and power charging for the mobile computing device. For example, when a cover with a battery is attached to the mobile computing device and a user is concurrently charging the mobile computing device while using it (e.g., currently talking on the phone while the phone is plugged into a charger that is plugged into a wall socket), the mobile computing device may automatically control both power consumption and power charging (i.e., which battery is being used and/or which battery is being charged). In other embodiments, the mobile computing device may automatically control or modify its power operations seamlessly, so that there is no interruption when a cover is attached or removed from the mobile computing device (e.g., if a user removes the cover with the battery while operating the mobile computing device, the user may still continue to operate the mobile computing device without the mobile computing device resetting).

Similarly, in another embodiment, power operations may be modified when a cover with a solar panel interface is attached to the mobile computing device. For example, because power may be provided to the mobile computing device via the mated communication ports and the solar power interface, the mobile computing device may determine how the internal battery of the mobile computing device is to be charged when it is plugged into a wall socket and when the attached cover is also exposed to sunlight. The mobile computing device may automatically cause the battery to be recharged by using sunlight, if possible, before recharging using the wall power outlet (or vice versa).

A cover may also include an inductive signal interface in combination with (or in place of) the solar panel interface and/or secondary battery. When this cover is engaged with the housing of the mobile computing device, the cover may receive power inductively from an inductive power source (a power source that is coupled to a corresponding inductive signal interface, e.g., which includes a primary coil). When the attached cover is in close proximity to or in contact with the inductive power source, the mobile computing device may receive power via the mated communication ports from the inductive signal interface of the cover. In some embodiments, the mobile computing device may modify its power operations so that it modifies the order of power consumption and/or power charging when the mobile computing device is engaged with the cover that includes an inductive signal interface.

As discussed above, each cover also includes a memory resource that is coupled to the communication port. In one embodiment, the memory resource stores data that identifies whether the cover is a power accessory and/or a data accessory, and what electrical or power components are included with the cover. In addition, the memory resource may include data corresponding to instructions for the mobile computing device to access (e.g., read and use) in order to effect a change or modification to its power operations. In other embodiments, the instructions for modifying the power operations may be stored in a memory resource of the mobile computing device (e.g., data corresponding to instructions for each type of cover that the mobile computing device may connect to can be stored in the memory resource of the mobile computing device). Other embodiments include the instructions being stored in a network server so that the mobile computing device may receive instructions for modifying power operations from an external source (e.g., through use of a network or cellular network).

In some embodiments, a user may manually modify the power operations of the mobile computing device after a cover is connected to the mobile computing device. Using input features (e.g., keyboard or touch screen display) of the mobile computing device, the user may manually change the default sequence of power consumption and/or power charging when the mobile computing device is connected to a power accessory cover.

Referring back to step 110, if an attached cover is a data accessory, the mobile computing device may process data in order to effect a change in its operations and/or functionalities (step 150). According to an embodiment, data corresponding to instructions for altering the operations and/or functionalities of the mobile computing device may be stored in a memory resource of the cover. In other embodiments, the instructions for modifying operations and/or functionalities may be stored in a memory resource of the mobile computing device. The mobile computing device may determine what data accessory cover is attached to it and access its own memory resource to determine how to modify its operations and/or functionalities. Other embodiments include the instructions being stored in a network server so that the mobile computing device may receive instructions for modifying its operations and/or functionalities from an external server (e.g., through use of a network or cellular network).

In some embodiments, a cover that is only a data accessory (e.g., is not also a power accessory as discussed above) may comprise a memory resource that is coupled to a communication port. Because there are no extra power components, a data accessory cover is used to change various mobile computing device operations and/or functionalities, such as changing an operation mode of the mobile computing device or modifying device settings. In other embodiments, a data accessory cover may be used to enable or disable data input. Depending on the data accessory cover that is attached to the mobile computing device, data may be processed (step 150) in order to modify or after the operations and/or functionalities of the mobile computing device.

After data is processed by the mobile computing device in step 150, various operations and/or functionalities may be modified in step 155, step 165 and step 175. In step 155, a mode of operation for the mobile computing device may be modified depending on the attached cover. A modal operation may include general operation modes for the mobile computing device (e.g., sleep mode, stand-by mode, silent mode, active mode), operations for enabling or disabling applications or other programs, operations for modifying application uses and functionalities, or operations for enabling or disabling user profiles.

For example, in step 160, the mobile computing device may modify its modal operations to prevent a user from accessing a mode or to enable the user to access a mode that was currently unavailable on the mobile computing device. In other embodiments, when the data accessory cover is attached to the mobile computing device, the mobile computing device may prevent the user from accessing one or more profiles (and contacts, calendars, messages, photographs associated with that profile), and enable the user to access a different profile. This may be beneficial when a mother, for example, has a work cell phone that she does not use on weekends. The mother may attach a data accessory cover belonging to her child (e.g., the data accessory cover may include a color or graphic design that the child likes or is associated with), which prevents her child from accessing her profile and instead allows the child to access his own profile.

In another embodiment, the data accessory cover may modify modal operations of the mobile computing device by disabling or enabling certain applications that are stored in the mobile computing device. Some programs and/or applications may be stored in the memory resource of the cover to enable a user to download the program and/or application or to enable the user to access the program and/or application directly from the memory resource. In some embodiments, modal operations of the mobile computing device may be modified by changing how an application functions and what a user can do when accessing that application. For example, an email application may be modified so that when a user writes an email message, a certain signature may be automatically added to the bottom of the email, or a music application may be modified so that when a user listens to the music application, certain songs are played back automatically. In another example, depending on the attached cover, the mobile computing device may change the overall theme of the appearance of the home screen, application launcher, etc. in order to match a color of the attached cover.

In other embodiments, after data is processed by the mobile computing device in step 150, device settings for the mobile computing device may be modified depending on the attached cover (step 165). Modifying device settings may include configuring various hardware of the mobile computing device, or causing a change in various user interface components of the mobile computing device (step 170).

For example, in step 170, when a cover that is green in color is attached to the mobile computing device, the mobile computing device may modify the device settings so that the mobile computing device matches the color scheme (e.g., change the backlighting of the display to be green, or change the backlighting of the keys to be green). Other hardware or user interface features that may be configured and modified include speaker volumes, vibration mechanisms, keyboard, etc. of the mobile computing device. In some embodiments, depending on the data accessory cover attached to the mobile computing device, the hardware can be configured so that the keys light up in a certain pattern or lighting when the phone rings for example, or while a user is playing a game.

The device settings that are configured or modified by the mobile computing device may correspond with the physical attribute or appearance of each cover. Colored covers may correspond to changing color schemes or display themes for the mobile computing device (in some instances, both the modal software operation and device settings can both be changed together), while textured covers may correspond to notification schemes for the mobile computing device (e.g., vibrations occur for different notifications, including changing the frequency and strength of the vibrations). In other embodiments, covers with graphic images may provide ring tones, sounds, or visual effects corresponding to the graphic image (e.g., if the image is a logo for a school, ring tone may be a school fight song) or may correspond with a child's profile (as discussed above).

In other embodiments, data may be processed to cause the mobile computing device to modify data input (step 175). In some instances, modal software operation, device settings and/or entry of data input may be changed together. For example, an attached data cover may enable or disable certain entry of data input. A user may be prevented from modifying contact information or from writing emails or text messages to anyone (or specific people) as a result of the attached data cover. In another example, a user may be enabled to edit profile information and have access to other databases or information that he or she was not previously allowed to provide input in.

While specific examples have been provided above with respect to modifying operations and/or functionalities, other various operations and/or functionalities of the mobile computing device may also be modified or altered.

As an alternative, as discussed previously, a cover may be both a power accessory and a data accessory. The mobile computing device may perform both sets of steps stemming from steps 140 and 150. For example, a cover may include a solar power interface and also have a certain color or graphic design associated with it. In other embodiments, by using input features (e.g., keyboard or touch screen display) of the mobile computing device, the user may manually change the operations and/or functionalities of the mobile computing device when the mobile computing device is connected to a data accessory cover. Additionally, the power accessory covers and data accessory covers may also be attached to or removed from the mobile computing device without having to reset or restart the mobile computing device. The mobile computing device may perform normally with or without the attached covers as the cover may be easily attached or removed by a user.

FIG. 2B is a flow chart illustrating a method for detecting a cover according to an embodiment. Other methods of detecting what type of cover is attached to the mobile computing device are also possible. A method such as described with FIG. 2B may be implemented using, for examples, elements shown and described with FIG. 1. As such, references to elements of FIG. 1 are intended to illustrate only suitable elements for performing a step or sub-step being described. Steps or sub-steps described may be performed by one or more processors of the mobile computing device using various programmatic elements.

The flow chart illustrated in FIG. 2B may correspond with step 110 of the flow chart in FIG. 2A. In FIG. 2B, at step 115, a user may choose one of many different covers to attach to the housing of the mobile computing device. Different mechanisms are available for enabling a cover to engage with the housing of the mobile computing device (e.g., various mechanical features such as clips, pins, hooks, latching members, screws and bolts, etc.). The cover may engage with the housing so that the cover and housing are flush about each other. In some embodiments, the engaging mechanisms make it difficult for the cover to accidentally fall off or disengage without the user making an active effort to disengage the cover from the mobile computing device.

Each of the variety of covers includes a communication port and a memory resource. The memory resource is coupled to the communication port to enable the mobile computing device to access data from the memory resource via the communication port. The communication port is configured to mate with an internal communication port of the mobile computing device when the cover is properly engaged with the housing of the mobile computing device. Once the cover is properly engaged with the housing, the communication port of the housing and the internal communication port of the mobile computing device are properly aligned and mated (step 120). In some embodiments, the mated communication ports may be used to transfer power and/or data between the cover and the mobile computing device.

In step 125, the mobile computing device is configured to read data stored in the memory resource via the mated communication ports. Depending on the cover, the data stored in the memory resource will vary, as the data corresponds to the type of cover and/or the components found with the cover. In step 130, the mobile computing device may determine from the data whether the cover is a power accessory and/or a data accessory. For example, a power accessory cover is a cover that may provide power to the mobile computing device, while a data accessory cover is a cover that enables a change in functionality or operations in a mobile computing device. In some embodiments, a detected cover may be both a power accessory and a data accessory. Upon detecting the cover, the mobile computing device may enable or modify different operations and/or functionalities.

### System

FIG. 2C illustrates a system for detecting a cover and for operating a mobile computing device under an embodiment. A system such as illustrated with FIG. 2C may be implemented on, for example, a mobile computing device. Implementation of the system may require use of memory, processing resources and network resources (including data ports and signal lines) of the mobile computing device. In some embodiments, the system illustrated may perform the steps and sub-steps described in FIGS. 2A and 2B.

In one embodiment, system 200 detects a cover that is engaged with the housing of the mobile computing device, and automatically performs or modifies various operations and/or functionalities of the mobile computing device. Various covers may be attached to the mobile computing device depending on user preference. Covers may be a power accessory and/or a data accessory.

Implementation of the system 200 may require use of memory, processing resources and network resources (including data ports and signal lines) of the mobile computing device. System 200 includes a cover detector 210 and a functionality and/or operation modifier 230 (hereinafter called “operation modifier”). The flow charts of FIGS. 2A and 2B may be implemented using, for example, elements shown and described with system 200. The cover detector 210 receives or reads data 220 from a memory resource of an attached cover. Each of the various covers that may be engaged with the mobile computing device includes a memory resource that stores data identifying what cover it is. The memory resource may also store information corresponding to the cover, such as instructions for modifying power operations and/or other operations or functionalities of the mobile computing device.

The cover detector 210 receives data 220 from the memory resource of an attached cover via the mated communication ports as discussed above. When a cover is properly engaged with the housing of the mobile computing device, the communication port of the cover is configured to mate with an internal communication port of the mobile computing device. Using the mated communication ports, the mobile computing device may exchange data and/or power with the attached cover. The cover detector 210 may read (or receive) data 220 from the memory resource of the attached cover to determine what cover is attached to the mobile computing device.

According to an embodiment, after the cover detector 210 determines what cover is attached to the mobile computing device (e.g., a power accessory and/or a data accessory) and what components (if any) the attached cover includes, detection information 250 may be sent to the operation modifier 230. In some embodiments, the detection information 250 may also include instructions for performing or modifying operations and/or functionalities of the mobile computing device if the instructions are stored in the memory resource of the attached cover. In other embodiments, the operation modifier 230 may receive instructions for modifying operations and/or functionalities from a memory resource of the mobile computing device. In an alternative embodiment, the operation modifier 230 may receive instructions for modifying operations and/or functionalities from a network server so that the mobile computing device may receive instructions for modifying power operations from an external source (e.g., through use of a network or cellular network and radio resources of the mobile computing device).

The operation modifier 230 may determine what operations and/or functionalities of the mobile computing device is to be performed, modified or altered, depending on the cover that is attached to the mobile computing device. In some embodiments, the operation modifier may also receive user input 240 to enable a user to manually update operations and/or change default settings. For example, a user may modify the power operation of the mobile computing device when a power accessory cover is attached to the mobile computing device, so that when the same cover is later attached a subsequent time after being interchanged, the manually modified power operation can be changed or altered when the power accessory cover is later attached.

### Covers

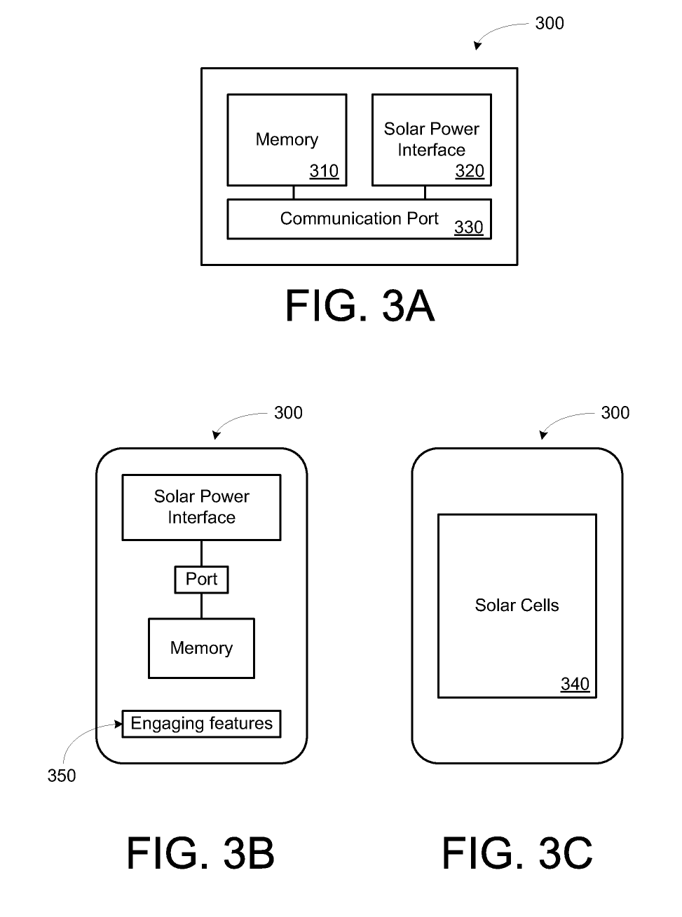

FIG. 3A illustrates a simplified block diagram of a cover for a mobile computing device under an embodiment. Cover 300 is an example of a power accessory that may be used to provide power to the mobile computing device when the cover 300 is properly attached to the mobile computing device. In some embodiments, cover 300 includes a memory resource 310, a solar power interface 320 and a communication port 330.

When the cover 300 is properly engaged with the housing of the mobile computing device, the communication port 330 will align with an internal communication port of the mobile computing device. Using the mated communication ports, the mobile computing device may detect what kind of cover is attached to it by receiving or reading data identifying the cover 300 from the memory resource 310. In addition, the cover 300 may be configured to provide power to the mobile computing device via the solar power interface 320 and mated communication ports. Thus, the mated communication ports may be used to exchange both power and data between the cover 300 and the mobile computing device.

FIGS. 3B and 3C illustrate a front view and rear view, respectively, of a cover for a mobile computing device, according to an embodiment. Although the cover 300 is illustrated to have curved corners, for example, covers may come in different sizes, shapes, forms, thicknesses, and may be formed with different materials, depending on the shape and design of the mobile computing device. In some embodiments, covers may engage with the housing of the mobile computing device on different faces (front, rear, side, etc.) so that the cover may be a front cover, a back cover, or a side cover, for example.

FIG. 3B illustrates a front view of the cover 300 showing the solar power interface 320, the communication port 330, and the memory resource 310 of the cover 300. In one embodiment, when the cover 300 is properly engaged with the housing of the mobile computing device, the solar power interface 320, communication port 330, and the memory resource 310 will not be visible to the user. The cover 300 also includes engaging features 350 that are used to attach the cover to the mobile computing device. Different mechanisms may be available for enabling the cover 300 to engage with the housing of the mobile computing device (e.g., various mechanical features such as clips, pins, latching members, screws and bolts, etc.). The cover 300 may engage with the housing of the mobile computing device so that the cover 300 and housing are flush about each other when properly attached. In some embodiments, the engaging features 350 make it difficult for the cover 300 to accidentally fall off or disengage without the user making an active effort to disengage the cover 300 from the mobile computing device. In some embodiments, when the cover 300 is properly engaged with the housing of the mobile computing device, the engaging features 350 will also be hidden from sight.

In the example provided, the solar panel interface 320 may include or be coupled to a plurality of solar cells 340 that are provided on a face of the cover 300 (see FIG. 3C). The solar cells 340 enable receipt of light energy when the cover 300 is engaged with the housing of the mobile computing device. The solar panel interface 320 may be used to receive solar energy from the solar cells 340 and convert it to generate power. The solar panel interface 320 is coupled to the communication port 330 of the cover to enable power transfer to the mobile computing device via the communication port 330 and the internal communication port of the mobile computing device (e.g., the mobile computing device may use the power from the solar panel interface 320 to recharge the battery of the mobile computing device).

Upon detecting the cover 300, the mobile computing device may modify the power operations or scheme in order to change the order or sequence in which the mobile computing device receives its power (e.g., from the internal battery first or from the solar power interface 320, provided that the solar power interface 320 is receiving solar energy). Similarly, in another example, when the cover 300 is attached to the mobile computing device and the mobile computing device is plugged into a wall socket, the mobile computing device may modify power operations by changing the order in which the mobile computing device recharges the battery. In other embodiments, power operations may be modified to change the order of both power consumption and power charging.

In another embodiment, cover 300 may be a power accessory and a data accessory. The memory resource 310 may include data for identifying the cover 300 as both a power accessory (because cover 300 has a solar power interface 320) and a data accessory. The mobile computing device may read or receive data from the memory resource 310 that corresponds to instructions for modifying or performing operations and/or functionalities of the mobile computing device. The cover 300 may include certain physical attributes that relate to the different modifications of the operation and/or functionality of the mobile computing device. The cover 300 may have a graphic image or design, a certain shape, one or more colors, or various textures.

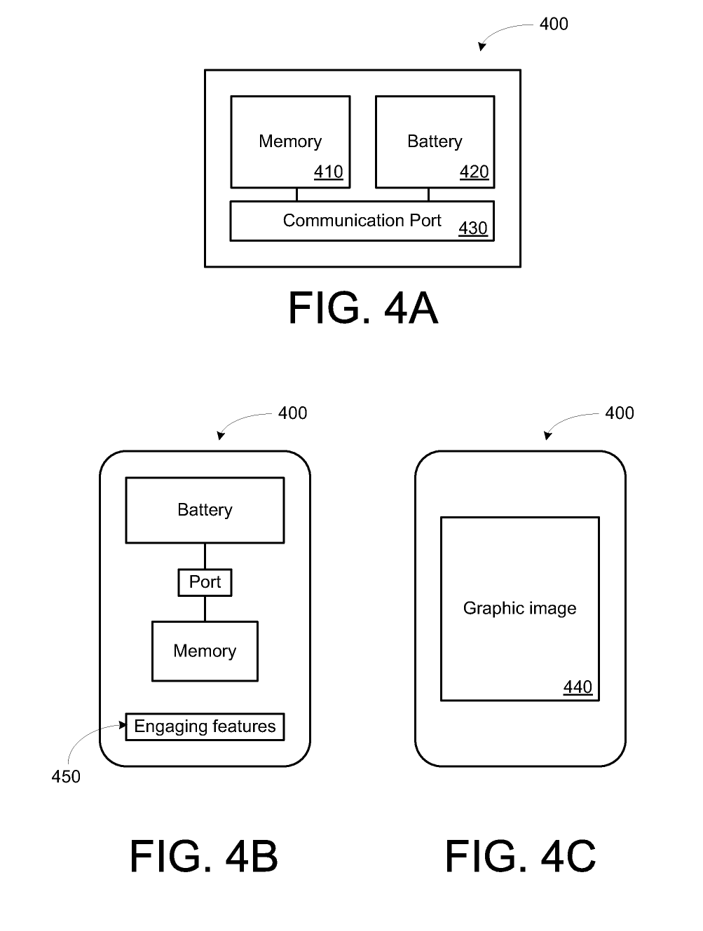

FIG. 4A illustrates a simplified block diagram of another cover for a mobile computing device under another embodiment. Cover 400 is an example of another power accessory that may be used to provide power to the mobile computing device when the cover 400 is properly attached to the mobile computing device. In some embodiments, cover 400 includes a memory resource 410, a battery 420 and a communication port 430.

Like cover 300, when the cover 400 is properly engaged with the housing of the mobile computing device, the communication port 430 will align with an internal communication port of the mobile computing device. Using the mated communication ports, the mobile computing device may detect what kind of cover is attached to it by receiving or reading data identifying the cover 400 from the memory resource 410. In this case, the mobile computing device detects the cover 400 and determines that the cover 400 includes a battery 420. The cover 400 may be configured to provide power to the mobile computing device via the battery 420 and mated communication ports.

FIGS. 4B and 4C illustrate a front view and rear view, respectively, of a cover for a mobile computing device, according to an embodiment. In one embodiment, when the cover 400 is properly engaged with the housing of the mobile computing device, the components shown on the face of the cover 400 (e.g., the front view shown in FIG. 4B) will not be visible to the user. The cover 400 may also include engaging features 450 that are used to attach the cover 400 to the mobile computing device. The engaging features 450 may be different mechanisms for enabling the cover 400 to engage with the housing of the mobile computing device (e.g., various mechanical features such as clips, pins, latching members, screws and bolts, etc.). The cover 400 may engage with the housing of the mobile computing device so that the cover 400 and housing are flush about each other when properly attached. The engaging features 350 may make it difficult for the cover 400 to accidentally fall off or disengage without the user making an active effort to disengage the cover 400 from the mobile computing device. In some embodiments, when the cover 400 is properly engaged with the housing of the mobile computing device, the engaging features 450 will be hidden from sight, like the other components of the cover 400.

In FIGS. 4A-4C, the cover 400 includes a battery 420 that is coupled to the communication port 430 of the cover 400. When the cover 400 is properly engaged with the housing of the mobile computing device, the battery 420 may provide power to the mobile computing device via the communication port 430 and the internal communication port of the mobile computing device. Depending on the types of covers, the mobile computing device may automatically modify power operations by modifying a charging scheme of its internal battery and the battery 420 of the cover 440. In other embodiments, the mobile computing device may modify its power usage.

For example, when the cover 400 is attached to the mobile computing device, the mobile computing device may automatically after the power consumption order so that power is first used from the battery 420 before using power from the internal battery of the mobile computing device. In another embodiment, when the mobile computing device is being charged (e.g., plugged into a cable that is attached to a power outlet), the mobile computing device may choose the order in which the batteries are to be charged (e.g., the battery 420 is to be recharged first (or second), or both batteries are recharged concurrently).

According to an embodiment, cover 400 may be both a power accessory and a data accessory. The memory resource 410 may include data for identifying the cover 400 as both a power accessory (because cover 400 has a battery 420) and a data accessory. The mobile computing device may read or receive data from the memory resource 410 that corresponds to instructions for modifying or performing operations and/or functionalities of the mobile computing device. The cover 400 may include certain physical attributes that relate to the different modifications of the operation and/or functionality of the mobile computing device. The cover 400 may have a graphic image 450, a certain shape, one or more colors, or various textures. The graphic image 450, for example, may be a picture of a cartoon character (for a child), a school logo, a company logo, etc. to help distinguish the cover 400 from other covers.

The covers illustrated and described with FIGS. 3A-3C and 4A-4C may each be connected to a mobile computing device so that the mobile computing device performs the methods as described with FIGS. 1A and 1B.

FIGS. 5A and 5B illustrate a cover being engaged with a mobile computing device according to an embodiment. FIG. 5A illustrates a side view of a mobile computing device 500 that includes a housing 510 and an internal communication port 520. The mobile computing device 500 includes other components (e.g., a keyboard, display, camera, audio ports, speakers, sliding mechanism for slider form factor devices, etc.), but are not illustrated for simplicity. In FIG. 5A, the mobile computing device 500 has its cover 550 removed. The cover 550 may be a default cover that may have come with the phone or a cover that may be a power accessory and/or a data accessory (such as described in various embodiments above).

A user may choose one of many different covers to attach to the mobile computing device 500. The cover 550 may be attached by engaging the cover 550 with the housing 510 of the mobile computing device 500. In one embodiment, the cover 550 can be brought into contact with the mobile computing device 500 in the direction 570 and engaged to the housing 510. When the cover 500 is properly engaged with the housing 510 (as discussed previously), the internal communication port 520 mates with the communication port 560 of the cover 500. As shown in FIG. 5B, when the cover 500 is properly engaged with the housing 510 of the mobile computing device 500, the internal components on one face of the cover 500 may not be visible to a user, while the other face 580 of the cover 500 may be visible.

Referring back to FIGS. 3A-3C, if the cover 550 is a power accessory that includes a solar panel interface with solar cells, the solar cells may be provided on the face 580 of the cover 550. This enables the solar cells to receive solar energy and provide power to the mobile computing device 500. In other embodiments, the cover 550 may have physical attributes that distinguish cover 550 from various other covers. The face 580 may have a graphic design, for example, or the cover 550 may have various shapes, colors, sizes, textures, etc. that differentiate a cover from another cover. The data stored in the memory resource of each cover may correspond to the physical attributes or characteristics of the cover.

In other embodiments, the cover 550 is shaped so that it may engage with the housing 510 of the mobile computing device 500 so that the cover 550 and the housing 510 are flush about each other. The face 580 may be the front face of the mobile computing device 500, or in another embodiment, the face 580 may be the rear face of the mobile computing device 500. Alternative embodiments include the cover 550 being a small portion of the housing 510 and not a full front face or rear face of the mobile computing device 500 (e.g., the cover 550 may be a side panel of the housing 510).

### Hardware Diagram

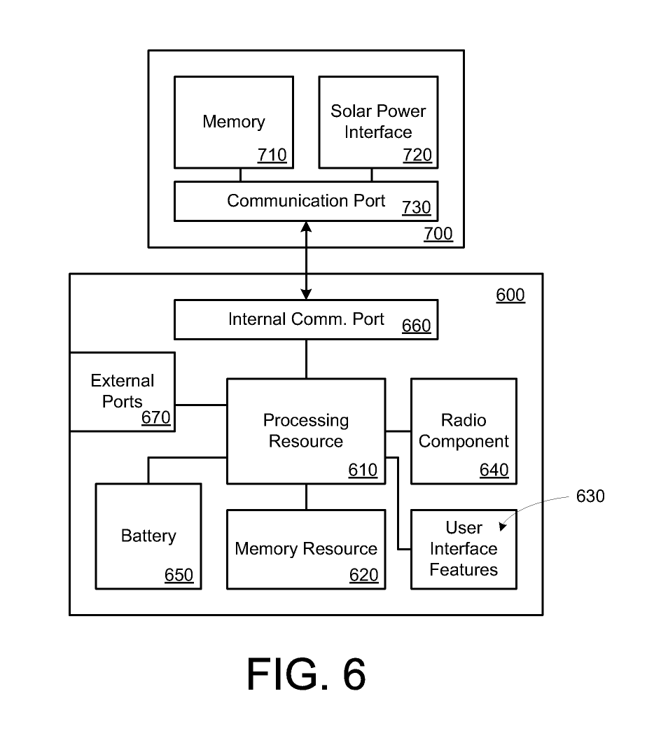

FIG. 6 is a simplified block diagram of a mobile device that is coupled with a cover under an embodiment. In FIG. 6, a mobile computing device 600 includes one or more processing resources 610, one or more memory resources 620 for storing applications, display features, and data used by the applications (e.g., Flash memory, RAM, hard drive, portable storage units, etc.), user interface features 630 for enabling a user to control the mobile computing device 600 with user inputs, and a radio and network resource 640. In some embodiments, the user interface features 630 include a keyboard, a microphone and speaker, and a display (e.g., touch screen display).

The mobile computing device 600 also includes a battery 650 for providing power to the mobile computing device 600 and an internal communication port 660. As discussed, the internal communication port 660 may be configured to mate with a corresponding communication port of a cover. The mobile computing device 600 also includes other ports 670 (e.g., an external port such as a USB or micro-USB port) for enabling other functionalities.

The processing resource 610 is configured to execute instructions and process data for implementing the method as described with FIGS. 1A and 1B, and the system 200 as described with FIG. 2, so that the mobile computing device 600 can detect a cover that is attached to it and modify or after various operations and/or functionalities. The radio and network resource 640 enables network connectivity and/or cellular telephony capabilities. The radio and network resource 640 can be configured to enable network connectivity or connectivity with other devices through use of the Wi-Fi protocol (e.g., IEEE 802.11(b) or (g) standards), Bluetooth protocol, etc.

FIG. 6 also includes a cover 700 that is engaged with the housing of the mobile computing device 600 (e.g., as shown in FIG. 5B). Once the cover 700 is properly engaged with the housing of the mobile computing device 600, the communication port 730 of the cover 700 mates with the internal communication port 660 of the mobile computing device 600. This enables the processing resource 610 to be able to detect the cover 700 via the internal communication port 660 and the communication port 730 of the cover 700. In an illustrated embodiment, the cover 700 also includes a memory resource 710 and a solar power interface 720. Memory resource 710 may store various data corresponding to the cover 700 and, in some embodiments, instructions for modifying operations and/or functionalities of the mobile computing device (e.g., Flash memory, RAM, hard drive, portable storage units, etc.). As previously discussed, various types of covers may couple or attach with the mobile computing device 600 so that the cover 700 may include, for example, a battery (instead of the solar power interface or in addition to the solar power interface). In other embodiments, the cover 700 may be a data accessory that includes a specific physical attribute.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

1. A mobile computing device comprising:
a housing;
an internal communication port;
one or more processors configured to:
detect whether a cover is a power accessory and/or a data accessory via the internal communication port, wherein the cover includes a corresponding communication port that is configured to mate with the internal communication port when the cover is engaged with the housing;
based on the detection, if the cover is a power accessory, modify power operations of the mobile computing device; and
based on the detection, if the cover is a data accessory, modify a functionality of the mobile computing device.

2. The mobile computing device of claim 1, wherein the cover includes a memory resource that is coupled to the corresponding communication port, the memory resource storing data identifying whether the cover is a power accessory and/or a data accessory.

3. The mobile computing device of claim 2, wherein the memory resource stores data corresponding to instructions for modifying power operations and/or modifying the functionality of the mobile computing device.

4. The mobile computing device of claim 2, wherein detecting whether the cover is a power accessory and/or a data accessory includes reading data stored in the memory resource via the internal communication port and corresponding communication port.

5. The mobile computing device of claim 1, wherein the cover includes at least one of: (i) a solar panel interface, or a (ii) a secondary battery.

6. The mobile computing device of claim 5, wherein modifying power operations of the mobile computing device includes at least one of: (i) modifying a charging scheme of a battery of the mobile computing device and the secondary battery of the cover, (ii) modifying a power usage of the mobile computing device, or (iii) modifying the power usage of the mobile computing device while the battery and secondary battery are being charged.

7. The mobile computing device of claim 1, wherein the internal communication port and corresponding communication port of the cover are mated in order to transfer power and/or data.

8. The mobile computing device of claim 1, wherein modifying a functionality of the mobile computing device includes changing an operation mode of the mobile computing device.

9. The mobile computing device of claim 8, wherein changing an operation mode of the mobile computing device includes locking or unlocking one or more features of the mobile computing device.

10. The mobile computing device of claim 8, wherein changing an operation mode of the mobile computing device includes preventing a user from accessing a profile of the mobile computing device.

11. The mobile computing device of claim 1, wherein modifying a functionality of the mobile computing device includes changing one or more settings of the mobile computing device.

12. The mobile computing device of claim 11, wherein changing one or more settings of the mobile computing device includes at least one of: (i) modifying user-interface settings of the mobile computing device, or (ii) modifying a notification scheme of the mobile computing device.

13. A cover for a mobile computing device comprising:
a communication port configured to mate with a corresponding internal communication port of the mobile computing device when the cover is engaged with the mobile computing device; and
a memory resource coupled to the communication port, the memory resource storing data that identifies, to the mobile computing device, whether the cover is a power accessory and/or a data accessory, wherein when the data identifies that the cover is a power accessory, the data causes the mobile computing device to modify power operations of the mobile computing device.

14. The cover of claim 13, wherein the cover is configured to engage with the mobile computing device so that the mobile computing device can detect, via the communication port and the corresponding internal communication port, whether the cover is a power accessory and/or a data accessory.

15. The cover of claim 14, wherein the memory resource stores data corresponding to instructions for modifying power operations and/or modifying a functionality of the mobile computing device.

16. The cover of claim 13, wherein the cover includes a battery that is coupled to the communication port, and wherein the memory resource stores data corresponding to instructions for modifying power operations of the mobile computing device.

17. The cover of claim 13, wherein the cover includes a solar power interface that is coupled to the communication port, and wherein the memory resource stores data corresponding to instructions for modifying power operations of the mobile computing device.

18. The cover of claim 13, wherein the cover includes a graphic design, and wherein the memory resource stores data corresponding to instructions for modifying a functionality of the mobile computing device relating to the graphic device.

19. The cover of claim 13, wherein the cover has a color, and wherein the memory resource stores data corresponding to instructions for modifying a functionality of the mobile computing device relating to the color.

20. The cover of claim 13, wherein the cover has a texture, and wherein the memory resource stores data corresponding to instructions for modifying a functionality of the mobile computing device relating to the texture.
